(19) United States
(12) Patent Application Publication
(10) Pub. No.: US 2015/0212548 A1
(43) Pub. Date: Jul. 30, 2015

(54) FLEXIBLE DISPLAY DEVICE

(71) Applicant: SAMSUNG DISPLAY CO., LTD., Yongin-City (KR)

(72) Inventors: Jun Namkung, Asan-si (KR); Soon Ryong Park, Sejong-si (KR); Chul Woo Jeong, Hwaseong-si (KR)

(21) Appl. No.: 14/453,553

(22) Filed: Aug. 6, 2014

(30) Foreign Application Priority Data
Jan. 29, 2014 (KR) 10-2014-0011723

(51) Int. Cl. G06F 1/16; G06F 3/044; G06F 3/041

(52) U.S. Cl. CPC G06F 1/1652; G06F 3/0412; G06F 3/044; G06F 1/1643; G06F 2203/04102

(57) ABSTRACT

A flexible display device includes a display panel including a flexible substrate, a display layer on the flexible substrate and including an electro-optical active layer, an encapsulation layer on the display layer, and a touch electrode layer. The touch electrode layer may include a first touch electrode layer under the display layer and including a plurality of first touch electrodes and a plurality of first touch signal lines coupled to the first touch electrodes, and a second touch electrode layer on the display layer such that the display layer is between the first touch electrode layer and the second touch electrode layer and including a plurality of second touch electrodes and a plurality of second touch signal lines coupled to the second touch electrodes.

### CROSS-REFERENCE TO RELATED APPLICATION

This application claims priority to and the benefit of Korean Patent Application No. 10-2014-0011723, filed in the Korean Intellectual Property Office on Jan. 29, 2014, the entire content of which is incorporated herein by reference.

### BACKGROUND

1. Field

Aspects of embodiments of the present invention relate to a flexible display device, and, more particularly, to a flexible display device including a touch sensor.

2. Description of the Related Art

Flat panel displays (FPD), such as an organic light emitting diode (OLED) display, a liquid crystal display (LCD), or an electrophoretic display (EPD), typically include a field generating electrode and an electro-optical active layer. For the electro-optical active layer, the OLED display includes an organic emission layer, the LCD includes a liquid crystal layer, and the EPD includes particles having a charge. The field generating electrode of these FPDs may receive a data signal through a connection to a switching element, such as a thin film transistor, and the electro-optical active layer may display an image by converting the data signal into an optical signal.

A display panel of these display devices typically uses a glass substrate, however, glass substrates can be heavy or easily damaged resulting in a limitation for in portability and size reduction. Accordingly, flexible display devices using (utilizing) a flexible plastic substrate that is light and resistant against impact have been developed.

These display devices may include a touch sensing function as well as the function for displaying an image such that they are capable of interaction with a user. A touch sensing function, in these devices, may determine whether a user's finger, etc., touches a screen, and touch position information thereof, by sensing a change of pressure, light, etc., that occurs on a screen in the display device when the user contacts the finger or a touch pen to the screen to write a character, to draw a picture, or otherwise utilize the device. These display devices may receive an image signal based on the touch information.

The touch sensing function in these display devices, for example, may be activated by a touch sensor including a touch electrode connected to a touch controller through a touch signal line receiving and transmitting the signal. These flexible display devices may have a shape in which a left and/or right region of the display area may be bent, however when the touch electrode or the touch signal line is located at the bent area, cracks may result. To prevent this, the touch signal line in these display devices may be designed to traverse the display area within the bent area, and as a result, a range of the touch active area capable of sensing the touch may be limited by the touch signal line.

The above information disclosed in this Background section is only for enhancement of understanding of the background of the invention and therefore it may contain information that does not form the prior art that is already known in this country to a person of ordinary skill in the art.

### SUMMARY

Aspects of embodiments of the present invention relate to a flexible display device having an expanded touch active area in the flexible display device including a touch sensor.

According to other aspects of embodiments of the present invention, a touch sensor in the flexible display device may be positioned and designed such that a touch signal line is not located within a bent area configured to be bent in the flexible display device.

A display device according to an embodiment of the present invention includes a display panel including a flexible substrate, a display layer on the flexible substrate and including an electro-optical active layer, an encapsulation layer on the display layer, and a touch electrode layer. The touch electrode layer may include a first touch electrode layer under the display layer and including a plurality of first touch electrodes and a plurality of first touch signal lines coupled to the first touch electrodes, and a second touch electrode layer on the display layer and including a plurality of second touch electrodes and a plurality of second touch signal lines coupled to the second touch electrodes.

The display device may further include a protection layer under the flexible substrate, such that the first touch electrode layer may be between the flexible substrate and the protection layer.

The display device may further include a polarization layer on the encapsulation layer. In an embodiment, the second touch electrode layer may be on the polarization layer. In another embodiment, the second touch electrode layer may be between the encapsulation layer and the polarization layer. In an embodiment, the second touch signal line may be in the polarization layer.

The polarization layer may include a plurality of layers, and the second touch electrode layer may be between two layers of the plurality of layers of the polarization layer.

The display panel may include a display area configured to display an image and a peripheral area around a perimeter of the display area. The display area may include a main display area and a bending display area at least at one side of the main display area.

The bending display area may not include the protection layer.

The bending display area may be at a right side and/or a left side of the main display area.

The first and second touch signal lines may be at the peripheral area of the main display area, for example at an upper side or a lower side, and may not extend into the bending display area.

The display panel may further include a touch active area configured to sense a touch, and the touch active area may substantially overlap with the main display area.

The first and second touch electrode layers may be at the main display area and the bending display area. The first and second touch electrode layers may include silver nanowire (AgNW), a metal mesh, carbon nanotubes (CNT), and/or graphene.

The first touch electrode and the second touch electrode may constitute a mutual sensing capacitor.

One of the first touch electrode and the second touch electrode may be a sensing input electrode, and the other may be a sensing output electrode.

The plurality of first touch electrodes may be positioned in columns, and the first touch electrodes in each column may be electrically coupled to each other by a first connection. The plurality of second touch electrodes may be positioned in columns, and the second touch electrodes in each column may be electrically coupled to each other by a second connection.

The columns in which the first touch electrodes are electrically coupled to each other and the columns in which the second touch electrodes are electrically coupled to each other may be substantially parallel to each other.

The first touch electrode layer and the second touch electrode layer may overlap each other with the display layer interposed therebetween.

According embodiments of the present invention, the flexible display device including the display panel in which the left and/or right regions are flexible within a bending display area may allow for the entire display area in the bending display area to include the touch active area. In the flexible display device, according to embodiments, the touch signal line may not extend into the bent area, helping prevent damage to the touch signal line or the touch electrode.

### BRIEF DESCRIPTION OF THE DRAWINGS

FIG. 1 is a schematic plan view of a display panel of a flexible display device including a touch sensor according to an embodiment of the present invention.

FIG. 2 is a schematic cross-sectional view of a structure of the display panel shown in FIG. 1 taken along the line A-A of FIG. 1.

FIGS. 3 through 8 are cross-sectional views of a polarization layer showing a position of a second touch electrode layer according to several embodiments of the present invention.

FIG. 9 is a plan view of a touch electrode and a touch signal line included in first and second touch electrode layers in a flexible display device according to an embodiment of the present invention.

FIG. 10 is across-sectional view of a structure of the display device according to another embodiment of the present invention taken along the line A-A of FIG. 1.

FIG. 11 is an equivalent circuit diagram of one pixel of a display device according to an embodiment of the present invention.

FIG. 12 is a plan view of one pixel of a display device according to an embodiment of the present invention.

FIG. 13 is a cross-sectional view of the pixel of the display device shown in FIG. 12 taken along the line B-B of FIG. 12.

### DETAILED DESCRIPTION

In the following detailed description, only certain embodiments of the present invention have been shown and described, simply by way of illustration. As those skilled in the art would realize, the described embodiments may be modified in various ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

A flexible display device including a touch sensor according to an embodiment of the present invention will be described with reference to accompanying drawings. Although an organic light emitting device is described with reference to the drawings, the present invention is not limited thereto and may be applied to other flat panel display devices.

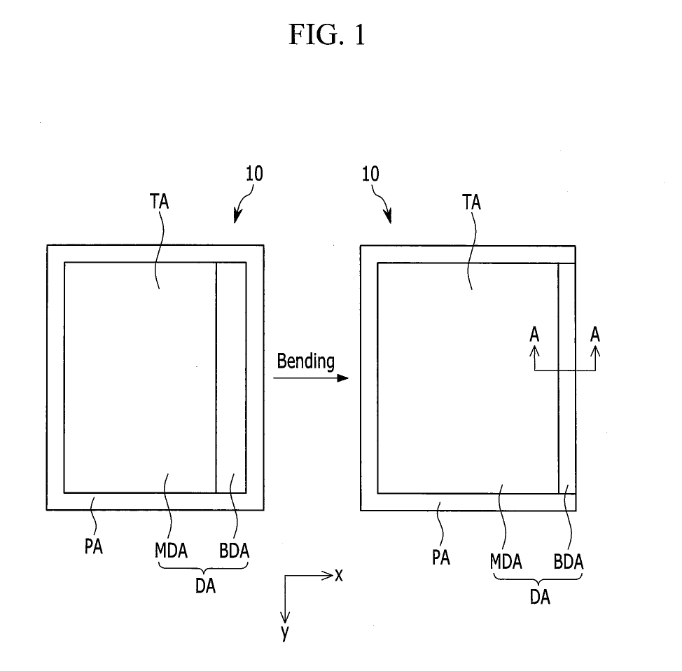

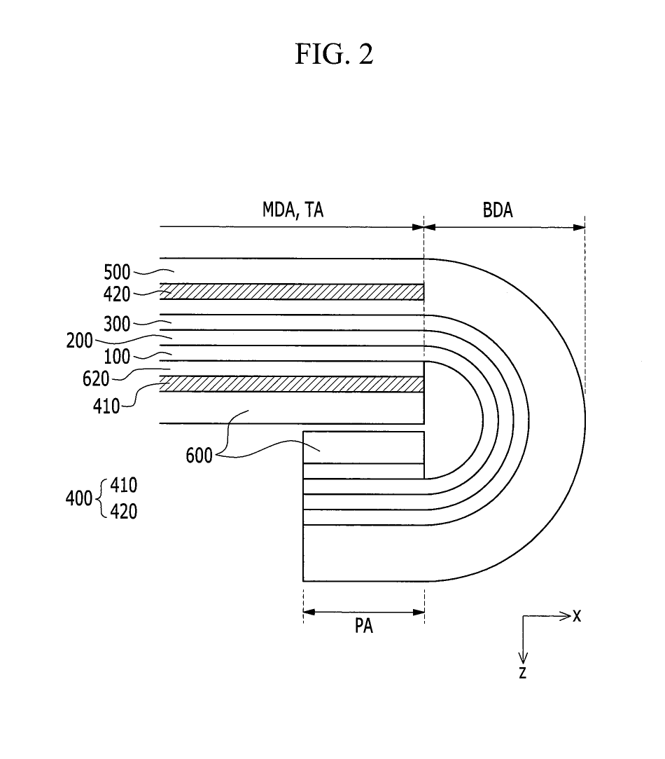

FIG. 1 is a schematic plan view of a display panel of a flexible display device including a touch sensor according to an embodiment of the present invention, and FIG. 2 is a schematic cross-sectional view of a structure of the display panel shown in FIG. 1 taken along the line A-A of FIG. 1.

Referring to FIGS. 1 2, in a flexible display device according to an embodiment of the present invention, a right edge region of a flexible display panel 10 may be bent in a rear direction (z-axis direction). The embodiment illustrated in FIG. 1 shows the display panel 10 before it is bent, on the left side of the drawing. Although a display device in which a right edge region of the display panel 10 is bent is described, the present invention is not limited thereto, and may be applied to a flexible display device in which at least one corner of the display panel 10 is bent.

The display panel 10, according to the embodiment, displays an image and senses a touch. The display panel 10, in this embodiment, includes a display area DA where an image is displayed, and a peripheral area PA around the periphery of the display area DA in a top plane structure.

The display area DA, in this embodiment, includes a main display area MDA and a bending display area BDA. The main display area MDA, according to an embodiment, may be a substantially flat area. The bending display area BDA, according to an embodiment, may have a length that is substantially the same as the main display area MDA, and a width that is considerably smaller than a width of the main display area MDA. According to an embodiment, the bending display area BDA may be only at a left side of the main display area MDA, or may be at both the left side and the right side.

The display area DA may include two areas MDA and BDA which may entirely display the same information, for example, one continuous image, in an embodiment. In this embodiment, the bending display area BDA may be considered as an expansion of the main display area MDA. Two areas MDA and BDA of the display area DA may display separate images or separate information, in an embodiment. For example, the main display area MDA may display the image, and the bending display area BDA may display text, a character message, or other information. According to an embodiment, the bending display area BDA may have display performance only at a partial region.

The partial or entire region of the display panel 10 may be a touch active area TA, in an embodiment. The touch active area TA, in this embodiment, is a region that may sense if an object approaches the touch display panel 10 or contacts the display panel 10. In this embodiment, contact includes a case an external object approaching the display panel 10 or hovering in the approached state as well as an external object such as a finger of a user directly contacting the display panel 10.

In an embodiment of the present invention, the touch active area TA may substantially overlap with the main display area MDA. In this embodiment, a touch may be substantially sensed in the entire region of the main display area MDA. However, according to an embodiment, the touch active area TA may also extend into the bending display area BDA or the peripheral area PA, or the touch active area TA may only extend into the main display area MDA.

Referring to the embodiment illustrated in FIG. 2, in the display panel 10, the main display area MDA, the bending display area BDA, and the peripheral area PA may have different layer structures.

The display panel 10, according to this embodiment, includes a flexible substrate 100, a display layer 200 on the flexible substrate 100, and an encapsulation layer 300 on the display layer 200. The display panel 10, in an embodiment, includes a protection layer 600 under the flexible substrate 100 and a polarization layer 500 on the encapsulation layer 300. The display panel 10, in an embodiment, may also include a touch electrode layer 400 including a first touch electrode layer 410 positioned under the display layer 200 and a second touch electrode layer 420 positioned on the display layer 200.

The display layer 200 positioned on the flexible substrate 100 and including an electro-optical active layer, in an embodiment, includes a plurality of display signal lines connected to a plurality of pixels and transmitting a driving signal, and is positioned within both the main display area MDA and the bending display area BDA. The display layer 200, in an embodiment, may also be positioned within the peripheral area PA as a dummy layer in which an image is not displayed.

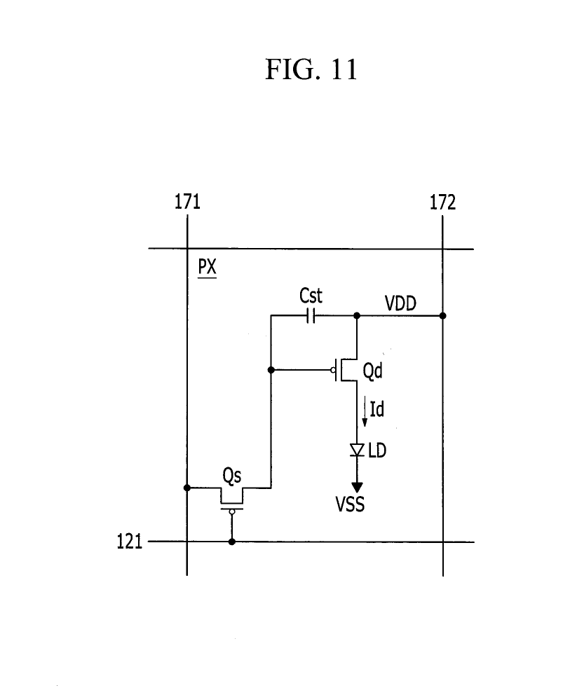

The display signal line, according to an embodiment, includes a plurality of gate lines 121 (for example, as shown in FIG. 11) transmitting a gate signal and a plurality of data lines 171 (for example, as shown in FIG. 11) transmitting a data signal. The gate lines 121 and the data lines 171, according to these embodiments, may extend to cross each other. The display signal line, in an embodiment, may extend into the peripheral area PA forming a pad portion.

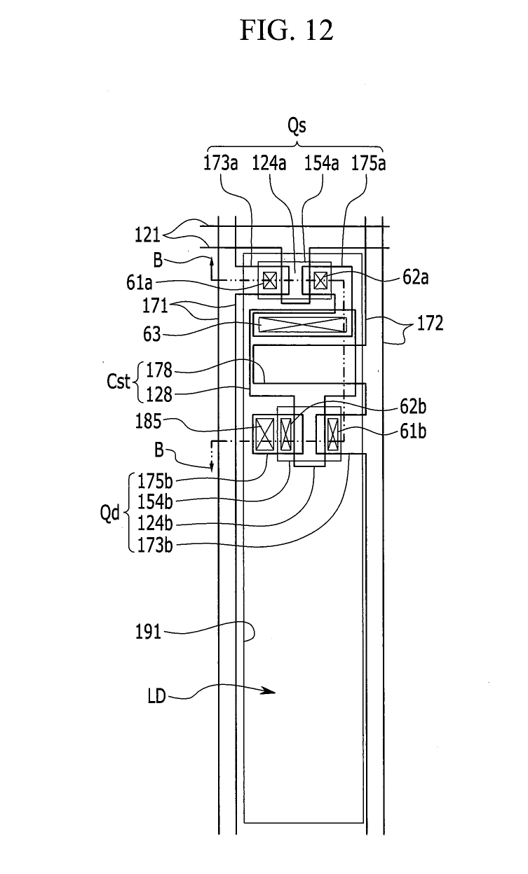

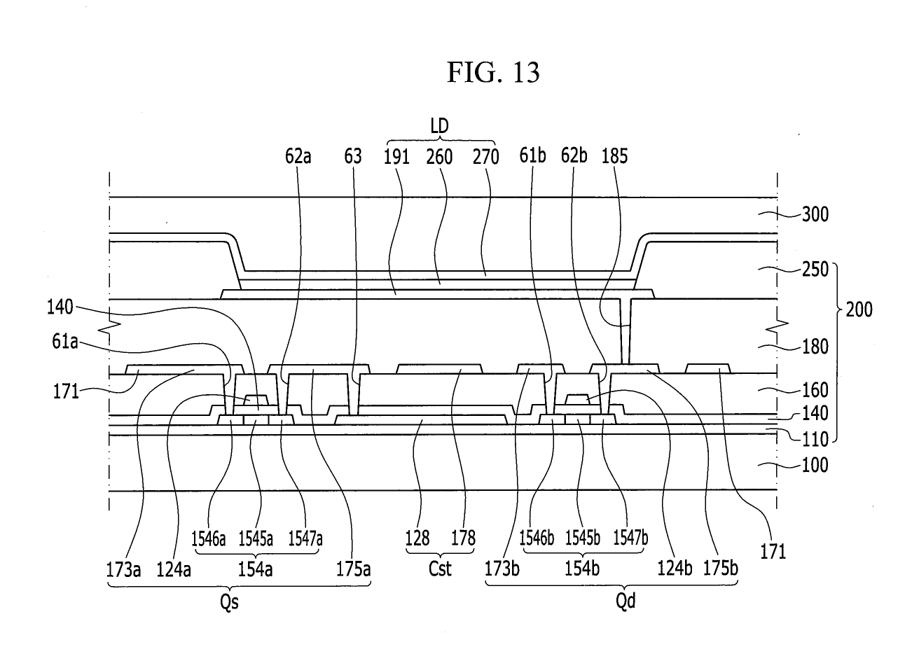

A plurality of pixels PX (for example, as shown in FIG. 11), in an embodiment, may be arranged in a matrix, but the plurality of pixels PX are not limited thereto. Each pixel PX, according to an embodiment, may include a switching element connected to the gate line 121 (for example, as shown in FIG. 11) and the data line 171 (for example, as shown in FIG. 11), and a pixel electrode 191 (for example, as shown in FIG. 12) connected thereto. The switching element, in this embodiment, may be a three-terminal element such as a thin film transistor integrated on the display panel 10. The switching element is turned on or off according to the gate signal transferred by the gate line 121 to selectively transfer the data signal transferred by the data line 171 to the pixel electrode 191, in this embodiment. The pixel PX, in an embodiment, may further include the pixel electrode 191 and a common electrode 270 (for example, as shown in FIG. 13) facing the pixel electrode 191. For example, in an organic light emitting diode display, an emission layer may be positioned between the pixel electrode 191 and the common electrode 270 to form a light emitting element, according to an embodiment. The common electrode 270 may transfer a common voltage VSS, in this embodiment.

The protection layer 600 to protect the flexible substrate 100, in an embodiment, is attached under the flexible substrate 100 by using (utilizing) an adhesive layer 620 such as a pressure sensitive adhesive (PSA) and/or an optically clear adhesive (OCA). However, in the bending display area BDA, the protection layer 600, according to this embodiment, may not allow for easy bending and increased bending degree. Thus, to maintain the bending flexibility of the display panel 10 in this embodiment, the protection layer 600 of the peripheral area PA may be coupled to the protection layer 600 of the main display area MDA.

The protection layer 600, in an embodiment, is a polymer plastic film and may include one material selected from a group including polyethylene terephthalate (PET), polyethylene naphthalate (PEN), polyethylene sulfide (PES), and polyethylene (PE).

The polarization layer 500 to reduce reflection of external light on the flexible display device, according to an embodiment, is positioned on the encapsulation layer 300. The polarization layer 500 may be coupled to the encapsulation layer 300, in an embodiment, using (utilizing) an adhesive layer, for example, OCA and/or PSA.

The touch electrode layer 400 positioned at the touch active area TA, according to an embodiment, includes the first touch electrode layer 410 and the second touch electrode layer 420. The first touch electrode layer 410, in an embodiment, is positioned under the display layer 200, and the second touch electrode layer 420, in an embodiment, is positioned on the display layer 200. For example, the first touch electrode layer 410, in an embodiment, may be positioned just above or directly on the protection layer 600 under the flexible substrate 100, and the second touch electrode layer 420, in an embodiment, may be positioned inside, on, or under the polarization layer 500 above the encapsulation layer 300.

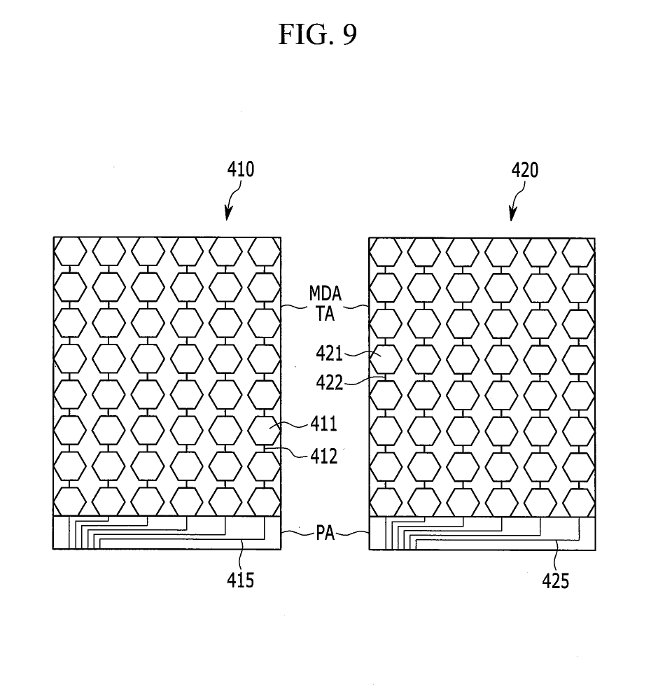

The first touch electrode layer 410, in an embodiment, includes a plurality of first touch electrodes 411 (for example, as shown in FIG. 9) and the second touch electrode layer 420, in this embodiment, includes a plurality of second touch electrodes 421 (for example, as shown in FIG. 9). The first touch electrode layer 410 and the second touch electrode layer 420, in an embodiment, are positioned at different layers such that a first touch signal line 415 (for example, as shown in FIG. 9) transmitting the touch signal to the first touch electrode 411 and a second touch signal line 425 (for example, as shown in FIG. 9) transmitting the touch signal to the second touch electrode 421 may both be positioned at the upper or lower peripheral area PA in a y-axis direction of the main display area MDA. Accordingly, the first and second touch signal lines 415 and 425, according to this embodiment, do not extend into the left and right both sides of the main display area MDA such that the touch electrode may be located throughout the entire main display area MDA, and the touch active area TA may, thus, substantially accord with the main display area MDA. Further, the touch signal line, in this embodiment, does not extend into the bending display area BDA, to thereby prevent (protect from) cracking of the bending display area BDA that may be generated by the bending.

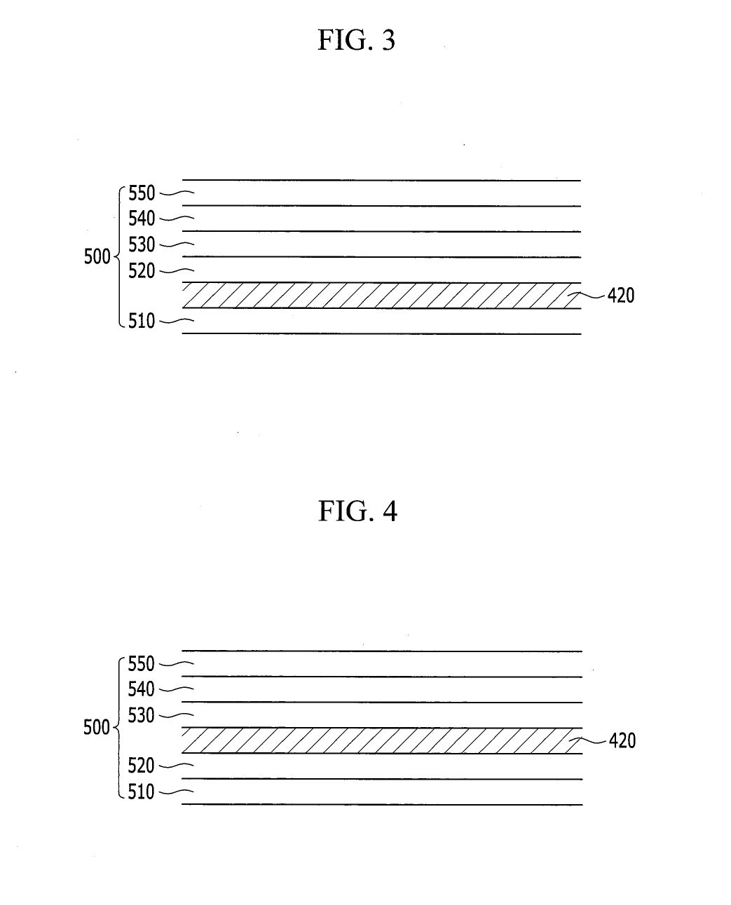

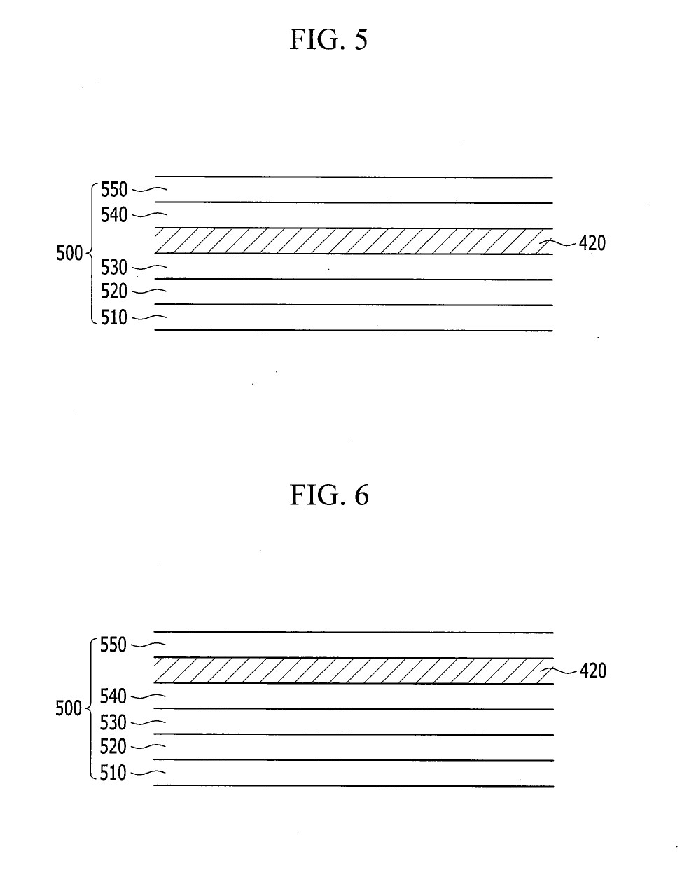

FIGS. 3 through 8 are cross-sectional views of a polarization layer showing a position of a second touch electrode layer according to several embodiments of the present invention.

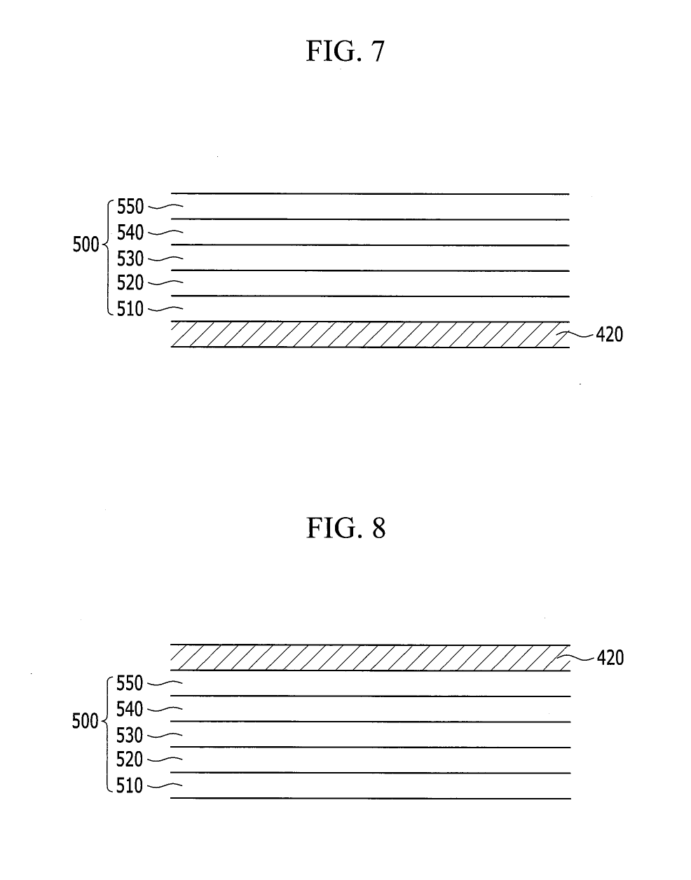

FIGS. 3 through 6 show example embodiments in which the second touch electrode layer 420 is positioned inside the polarization layer 500, and FIGS. 7 and 8 show example embodiments in which the second touch electrode layer 420 is positioned at an outer surface of the polarization layer 500.

Referring to FIGS. 3 through 7, the polarization layer 500, according to an embodiment of the present invention, includes a plurality of layers 510, 520, 530, 540, and 550. The polarization layer 500, in this embodiment, includes a ¼λ retarder film 510 and a linear polarizer 540. The phase retardation or ¼λ retarder film 510, in this embodiment, may be formed of a material such as a cyclo-olefin polymer (COP), and the linear polarizer 540, in this embodiment, may be formed of a material such as polyvinyl alcohol (PVA). In an embodiment, protection films 530 and 550 formed of a material such as triacetyl cellulose (TAC) may be laminated at respective surfaces of the linear polarizer 540, and the protection film 530 may be coupled to the ¼λ retarder film 510 using (utilizing) an adhesive layer 520 such as PCA and/or OCA. The rest of the layers, except for the adhesive layer 520, in an embodiment, may all be formed of a plastic film such that the second touch electrode layer 420 may be patterned and formed on or under any one of them. The layer formed with the second touch electrode layer 420 may be coupled to other layers using (utilizing) an adhesive, according to an embodiment. According to an embodiment, the second touch electrode layer 420 may be formed by transferring an electrode pattern formed by using (utilizing) an imprinting technique to one layer of the layers 510, 530, 540, and 550 forming the polarization layer 500, or to another plastic layer.

The second touch electrode layer 420, according to an embodiment, may be patterned on a separate plastic material made of PET, PEN, PC, or polypropylene (PP), and may then be coupled to the polarization layer 500. The first touch electrode layer 410, according to an embodiment, may also be patterned on a separate plastic material that is not the protection layer 600, and may then be coupled to the protection layer 600.

Next, a structure of the touch electrode and a touch sensing principle according to an embodiment of the present invention will be described with reference to FIG. 9.

FIG. 9 is a plan view of a touch electrode and a touch signal line included in first and second touch electrode layers in a flexible display device according to an embodiment of the present invention.

The first touch electrode layer 410 and the second touch electrode layer 420, according to an embodiment, are positioned at different layers, for example, having at least the display layer 200 interposed therebetween. As illustrated in the embodiment in FIG. 9, the left drawing is a top plan view showing one example of the first touch electrode layer 410, and the right drawing is a top plan view showing one example of the second touch electrode layer 420. The first touch electrode layer 410, in this embodiment, includes a plurality of first touch electrodes 411, and the second touch electrode layer 420, in this embodiment, also includes a plurality of second touch electrodes 421.

The plurality of first touch electrodes 411, in an embodiment, may be positioned along a column direction, and the first touch electrode 411 positioned at the column (hereinafter referred to as a first touch electrode column) may be electrically connected to each other by a first connection 412. The plurality of second touch electrodes 421, in an embodiment, may be positioned along the column direction, and the second touch electrodes 421 positioned at the column (hereinafter referred to as a second touch electrode column) may be electrically connected to each other by a second connection 422. The column direction of the first touch electrode 411 and the column direction of the second touch electrode 421, in an embodiment, may be parallel to each other, or may be slightly oblique. The first touch electrode 411 and the second touch electrode 421 may be hexagonal in shape, as shown in the embodiment illustrated in FIG. 9, however the shape of the first touch electrode 411 and the second touch electrode 421 are not limited thereto. For example, the first touch electrode 411 and the second touch electrode 421 may be polygonal in shape, according to an embodiment, such as triangular, quadrangular, or pentagonal, and in addition, may have various other sutiable shapes, for example circular or ovular. The first touch electrode 411 and the second touch electrode 421 may have the same shape or different shapes, according to embodiments of the present invention.

The first touch electrode 411 and the second touch electrode 421, in an embodiment, may be positioned within different layers such that they are disconnected from each other, however, in an embodiment, they may completely overlap via the display layer 200 therebetween in the touch active area TA or they may partially overlap.

In an embodiment, a first touch signal line 415 is connected to a lower end of the lowest first touch electrode 411 of each first touch electrode column, and a second touch signal line 425 is connected to a lower end of the lowest second touch electrode 421 of each second touch electrode column. The first touch signal line 415 and the second touch signal line 425, in this embodiment, are positioned at the lower peripheral area PA of the main display area MDA in the peripheral area PA of the display panel 10. In an embodiment, the end of the first touch signal line 415 and the second touch signal line 425 may form a pad portion in the peripheral area PA. According to an embodiment, the first and second touch signal lines 415 and 425 may be positioned at the upper peripheral area PA of the main display area MDA. According to an embodiment of the present invention, the first and second touch signal lines 415 and 425 may be positioned in the upper and lower peripheral areas PA of the main display area MDA such that the touch signal lines may be prevented from being damaged when the left and/or left region of the display panel 10 is bent in the use of the flexible display device. In an embodiment, the entire main display area MDA may be formed of the touch active area TA. The second touch electrodes 421, according to an embodiment, may have transmittance of more than a set or predetermined degree so that light from the display layer 200 can be transmitted. For example, the second touch electrode 421, in an embodiment, may be made of a transparent conductive material such as indium tin oxide (ITO), indium zinc oxide (IZO), a thin metal layer such as silver nanowire (AgNw), a metal mesh, carbon nanotubes (CNT), graphene, and/or a graphene oxide. The first touch electrode 411, according to an embodiment, may be formed from the same material as the second touch electrode 421, however the light from the display layer 200, in this embodiment, is only emitted in the direction of the second touch electrode 421 to prevent (or protect from) limiting the transmittance characteristic.

The first and second touch signal lines 415 and 425, according to an embodiment, may be formed of a metal material such as molybdenum (Mo), silver (Ag), titanium (Ti), copper (Cu), aluminum (Al), or molybdenum/aluminum/molybdenum (Mo/Al/Mo). According to an embodiment, the first and second touch signal lines 415 and 425 may be formed of the transparent conductive material forming the first touch electrode 411 and the second touch electrode 421.

In an embodiment, the first connections 412 connecting the first touch electrodes 411 in the column direction may be formed of the same material as the first touch electrode 411 or a different material. In the former embodiment, the first connections 412 may be integrally formed to be concurrently or simultaneously patterned with the first touch electrodes 411, while in the latter embodiment, after the first connections 412 are formed, the first touch electrodes 411 may be formed to be electrically connected to the first connections 412, for example, through direct contact. The second connections 422 connecting the second touch electrodes 421 in the column direction, according to these embodiments, is the same as the first connections 412, and is not repeated herein.

The touch sensor of the first and second touch electrodes 411 and 421 of the first and second touch electrode layers 410 and 420, according to an embodiment, may sense contact through various suitable methods. The touch sensor, according to an embodiment, may be divided into various types (kinds) such as a resistive type (kind), a capacitive type (kind), an electro-magnetic type (kind), and/or an optical type (kind). In the present embodiment, the capacitive type (kind) of touch sensor is described.

The first touch electrode 411 and the second touch electrode 421 that are vertically adjacent to each other, in an embodiment, form a mutual sensing capacitor functioning as a touch sensing sensor. The mutual sensing capacitor may be a sensing input electrode receiving the sensing input signal through one of the first touch electrode 411 and the second touch electrode 421, and the other one may be a sensing output electrode outputting a charge amount change by the contact of the external object as a sensing output signal, in an embodiment. If the sensing input signal applied through the touch signal line from the touch controller is input into the sensing input electrode, according to an embodiment, the mutual sensing capacitor is charged with a set or predetermined charge amount, with the charge amount depending on the touch as the sensing output signal is output to the touch controller through the sensing output electrode and the detection signal line. The touch controller, in this embodiment, processes the sensing output signal to generate touch information such as the touch existence and the touch position. Throughout the specification, the sensing input signal and the sensing output signal are together referred to as a “touch signal.”

In an embodiment, the first touch electrode layer 410 is positioned under the display layer 200 such that the touch signal of the second touch electrode 421 has a weak intensity or is covered by noise generated in the display layer 200 such that the detection thereof may be difficult. Accordingly, the touch controller, in this embodiment, may perform signal processing through an algorithm for amplifying the touch signal of the second touch electrode 421 and removing the noise.

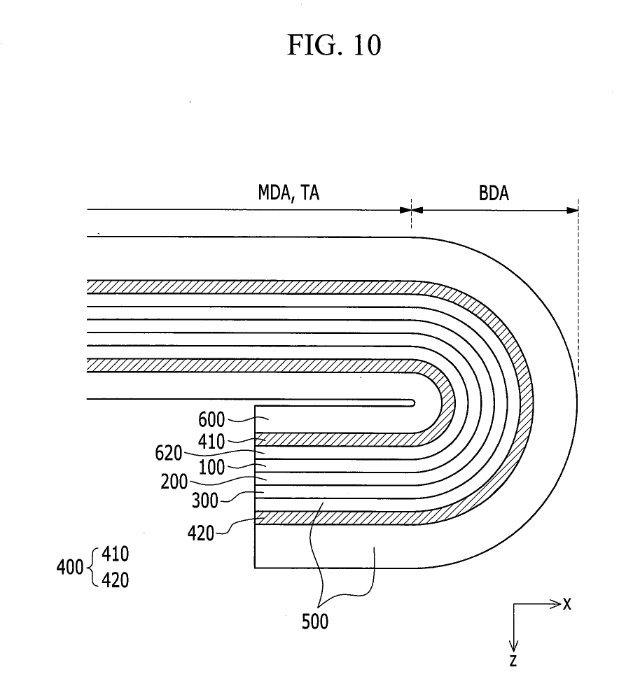

FIG. 10 is a cross-sectional view of a structure of the display device according to another embodiment of the present invention taken along the line A-A of FIG. 1.

In the embodiment illustrated in FIG. 10, the main display area MDA and the bending display area BDA have substantially the same structure.

Referring to FIG. 10, the first and second touch electrode layers 410 and 420 forming the touch sensor, according to an embodiment, may be in the bending display area BDA as well as the main display area MDA. In this embodiment, FIG. 10 shows a structure in which the touch electrode layer 400 is also bent with the display layer 200. The first touch electrode layer 410, in this embodiment, extends through the bending display area BDA along with the protection layer 600 that may be positioned on the first touch electrode layer 410 and the adhesive layer 620 used to couple the protection layer 600 to the flexible substrate 100. At least a portion of the region that is passed through the bending display area BDA and is positioned under the main display area MDA in the z-axis direction, according to this embodiment, may be the display area DA and the touch active area TA, or the peripheral area PA of a non-display area.

In an embodiment, when forming the touch electrode layer 400, the touch active area TA may extend to at least the bending display area BDA. However, since the touch electrode layer 400 can be bent according to this embodiment, it may be formed of a material having excellent strain characteristic such as silver nanowire (AgNW), a metal mesh, carbon nanotubes (CNT), or graphene, to prevent cracking.

Next, a pixel PX of the organic light emitting device LD according to an embodiment of the present invention will be described with reference to FIGS. 11 through 13.

FIG. 11 is an equivalent circuit diagram of one pixel of a display device according to an embodiment of the present invention, FIG. 12 is a plan view of one pixel of a display device according to an embodiment of the present invention, and FIG. 13 is a cross-sectional view of the pixel of the display device shown in FIG. 12 taken along the line B-B of FIG. 12.

As described above, the display layer 200, according to this embodiment, may include a plurality of switching and driving thin film transistors Qs and Qd, a plurality of storage capacitors Cst, and a plurality of light-emitting devices LD. The display layer 200, according to this embodiment, includes a plurality of pixels PX.

Referring to the embodiment illustrated in FIG. 11, the display device includes a plurality of signal lines 121, 171, and 172, and a plurality of pixels PX connected thereto and arranged substantially in a matrix.

The signal lines, in this embodiment, include a plurality of gate lines 121 transmitting a gate signal, a plurality of data lines 171 transmitting a data signal, and a plurality of driving voltage lines 172 transmitting a driving voltage VDD. The gate lines 121, in this embodiment, may extend in a row and be substantially parallel to each other, and the data lines 171 and the driving voltage lines 172, in this embodiment, may extend in a column and be substantially parallel to each other. The gate signal and the data signal may be applied through a display controller, in an embodiment.

Each pixel PX, in this embodiment, includes a switching thin film transistor Qs, a driving thin film transistor Qd, a storage capacitor Cst, and a light emitting device LD.

The switching thin film transistor Qs, in an embodiment, includes a control terminal, an input terminal, and an output terminal. In an embodiment, the control terminal is connected to the gate line 121, the input terminal is connected to the data line 171, and the output terminal is connected to the driving thin film transistor Qd. The switching thin film transistor Qs, according to this embodiment, transfers the data signal applied to the data line 171 to the driving thin film transistor Qd in response to the gate signal applied to the gate line 121.

The driving thin film transistor Qd, in an embodiment, also has a control terminal, an input terminal, and an output terminal, in which the control terminal is connected to the switching thin film transistor Qs, the input terminal is connected to the driving voltage line 172, and the output terminal is connected to the light emitting device LD. The driving thin film transistor Qd, according to this embodiment, flows an output current Id for which the magnitude varies depending on a voltage applied between the control terminal and the output terminal.

The storage capacitor Cst, in an embodiment, is connected between the control terminal and the input terminal of the driving thin film transistor Qd. The storage capacitor Cst, according to this embodiment, charges the data signal applied to the control terminal of the driving thin film transistor Qd and maintains the charged data signal even after the switching thin film transistor Qs is turned off.

According to an embodiment, the light emitting device LD, which may be an organic light emitting diode, includes an anode which is connected to the output terminal of the driving thin film transistor Qd, and a cathode which is connected to a common voltage VSS. The light emitting device LD, according to this embodiment, displays an image by emitting light having varying strength depending on the output current Id of the driving thin film transistor Qd.

The switching thin film transistor Qs and the driving thin film transistor Qd, according to an embodiment, may be n-channel field effect transistors (FET) or p-channel field effect transistors. A connection relationship among the switching and driving thin film transistors Qs and Qd, the storage capacitor Cst, and the light emitting device LD, according to other embodiments, may be altered from that described.

Referring to FIGS. 12 and 13, the display device according to the an embodiment includes the flexible substrate 100, the display layer 200 positioned on the flexible substrate 100, and the light-emitting device LD.

The flexible substrate 100, according to an embodiment, may be made of a transparent polymer film. For example, the flexible substrate 100, in an embodiment, may be made of a plastic such as a thermoplastic semicrystalline polymer (such as polyethylene terephthalate (PET), polyethylene naphthalate (PEN), or polyethylene ether ketone (PEEK)), a thermoplastic amorphous polymer (such as polycarbonate (PC) or polyethylene sulfonate (PES)), polyimide (PI) having relatively high thermal resistance, or polyarylate (PAR).

The display layer 200, in an embodiment, includes a buffer layer 110, switching and driving semiconductor layers 154a and 154b, a gate insulating layer 140, the gate line 121, a first capacitor plate 128, an interlayer insulating layer 160, the data line 171, the driving voltage line 172, a switching drain electrode 175a, a driving drain electrode 175b, and a passivation layer 180. The display layer 200, in other embodiments, may also include the light-emitting device LD and a pixel defining layer 250.

The buffer layer 110, in an embodiment, may be formed on the flexible substrate 100 and may include a silicon nitride (SiNx), a silicon oxide (SiOx), a silicon oxynitride (SiOxNy), or the like, and may be formed as a single layer or a multilayer. The buffer layer 110, according to these embodiments, may prevent impurities, moisture, or external air, which degrade characteristics of the semiconductor, from permeating, and serve to planarize the surface. According to an embodiment, the buffer layer 110 may be positioned within the flexible substrate 100. For example, in an embodiment, the flexible substrate 100 may have a structure in which the polymer film (the plastic layer) and the buffer layer 110 are alternately multi-layered.

The switching semiconductor layer 154a and the driving semiconductor layer 154b, in an embodiment, may be on the buffer layer 110 while being spaced apart from each other. The switching semiconductor layer 154a and the driving semiconductor layer 154b, in an embodiment, may be made of polycrystalline silicon, and may include channel regions 1545a and 1545b, source regions 1546a and 1546b, and drain regions 1547a and 1547b. The source regions 1546a and 1546b and the drain regions 1547a and 1547b, in this embodiment, may be at respective sides of the channel regions 1545a and 1545b.

The channel regions 1545a and 1545b, according to an embodiment, may be polycrystalline silicon not doped with an impurity, e.g., intrinsic semiconductors, and the source regions 1546a and 1546b may be polycrystalline silicon doped with a conductive impurity, e.g., impurity semiconductors.

The gate insulating layer 140, in an embodiment, is on the channel regions 1545a and 1545b of the switching semiconductor layer 154a and the driving semiconductor layer 154b. The gate insulating layer 140, in this embodiment, may be formed in a single layer or a multilayer which includes at least one of a silicon nitride and a silicon oxide.

The gate line 121, in an embodiment, is on the gate insulating layer 140, and the first capacitor plate 128, in an embodiment, is on the buffer layer 110.

The gate line 121, in an embodiment, extends in a horizontal direction to transfer the gate signal, and includes a switching gate electrode 124a which extends from the gate line 121 to the switching semiconductor layer 154a. The first capacitor plate 128, in an embodiment, includes a driving gate electrode 124b which extends from the first capacitor plate 128 to the driving semiconductor layer 154b. The switching gate electrode 124a and the driving gate electrode 124b, in an embodiment, each overlap the channel regions 1545a and 1545b.

The interlayer insulating layer 160, in an embodiment, is on the gate line 121, the first capacitor plate 128, and the buffer layer 110. The interlayer insulating layer 160, in this embodiment, includes a switching source contact hole 61a and a switching drain contact hole 62a which each expose the source region 1546a and the drain region 1547a, respectively, of the switching semiconductor layer 154a. In an embodiment, the interlayer insulating layer 160 may have a driving source contact hole 61b and a driving drain contact hole 62b which expose the source region 1546b and the drain region 1547b, respectively, of the driving semiconductor layer 154b.

The data line 171, the driving voltage line 172, the switching drain electrode 175a, and the driving drain electrode 175b, in an embodiment, are on the interlayer insulating layer 160.

The data line 171, in an embodiment, transfers the data signal, extends in a direction intersecting with the gate line 121, and includes a switching source electrode 173a which extends toward the switching semiconductor layer 154a from the data line 171.

The driving voltage line 172, in an embodiment, transfers the driving voltage VDD, is separated from the data line 171, and extends in the same direction as the data line 171. The driving voltage line 172, in an embodiment, includes a driving source electrode 173b which extends toward the driving semiconductor layer 154b from the driving voltage line 172, and a second capacitor plate 178 which extends from the driving voltage line 172 to overlap the first capacitor plate 128. The storage capacitor Cst, according to an embodiment, includes the first capacitor plate 128 and the second capacitor plate 178, using (utilizing) the interlayer insulating layer 160 as a dielectric material.

The switching drain electrode 175a, in an embodiment, faces the switching source electrode 173a, and the driving drain electrode 175b, in an embodiment, faces the driving source electrode 173b.

The switching source electrode 173a and the switching drain electrode 175a, in an embodiment, are each connected to the source region 1546a and the drain region 1547a of the switching semiconductor layer 154a through the switching source contact hole 61a and the switching drain contact hole 62a. Further, the switching drain electrode 175a, in an embodiment, is electrically connected to the first capacitor plate 128 and the driving gate electrode 124b through a first contact hole 63 which is defined in the interlayer insulating layer 160.

The driving source electrode 173b and the driving drain electrode 175b, in an embodiment, are each connected to the source region 1546b and the drain region 1547b of the driving semiconductor layer 154b through the driving source contact hole 61b and the driving drain contact hole 62b.

The switching semiconductor layer 154a, the switching gate electrode 124a, the switching source electrode 173a, and the switching drain electrode 175a, in an embodiment, form the switching thin film transistor Qs, and the driving semiconductor layer 154b, the driving gate electrode 124b, the driving source electrode 173b, and the driving drain electrode 175b, in an embodiment, form the driving thin film transistor Qd.

The passivation layer 180, in an embodiment, is positioned on the data line 171, the driving voltage line 172, the switching drain electrode 175a, and the driving drain electrode 175b. The passivation layer 180, in an embodiment, defines a second contact hole 185 which exposes the driving drain electrode 175b.

The light emitting device LD and the pixel defining layer 250, in an embodiment, are on the passivation layer 180.

The light emitting device LD, in an embodiment, includes a pixel electrode 191, an organic emission layer 260, and a common electrode 270.

The pixel electrode 191, in an embodiment, is on the passivation layer 180 and is electrically connected to the driving drain electrode 175b of the driving thin film transistor Qd through the second contact hole 185 defined in the interlayer insulating layer 160. The pixel electrode 191, in an embodiment, is the anode of the light emitting device LD. The pixel electrode 191, in this embodiment, may be made of a transparent conductive material such as ITO, IZO, ZnO, and/or In2O3, or a reflective metal such as lithium (Li), calcium (Ca), lithium fluoride/calcium (LiF/Ca), lithium fluoride/aluminum (LiF/Al), aluminum (Al), silver (Ag), magnesium (Mg), and/or gold (Au).

The pixel defining layer 250, in an embodiment, is on an edge portion of the pixel electrode 191 and the passivation layer 180. The pixel defining layer 250, in an embodiment, may have an opening through which the pixel electrode 191 is exposed. The pixel defining layer 250, in an embodiment, may be made of a resin such as a polyacrylate and/or a polyimide.

The organic emission layer 260, in an embodiment, is on the pixel electrode 191 within the opening of the pixel defining layer 250. The organic emission layer 260, in this embodiment, includes an emission layer, and may be formed as a multilayer including a hole injection layer (HIL), a hole transport layer (HTL), an electron transport layer (ETL), and/or an electron injection layer (EIL). In an embodiment where the organic emission layer 260 includes all of the layers HIL, HTL, ETL, and EIL, the hole injection layer may be on the pixel electrode 191, which is an anode, and the hole transport layer, the emission layer, the electron transport layer, and the electron injection layer may be sequentially stacked thereon.

The organic emission layer 260, according to an embodiment, may include a red organic emission layer which emits red light, a green organic emission layer which emits green light, and a blue organic emission layer which emits blue light, in which the red organic emission layer, the green organic emission layer, and the blue organic emission layers are respectively formed in a red pixel, a green pixel, and a blue pixel to implement color images. The organic emission layer 260, in this embodiment, may also implement color images by stacking the red organic emission layer, the green organic emission layer, and the blue organic emission layer in each of the red pixel, the green pixel, and the blue pixel, and forming a red color filter, a green color filter, and a blue color filter for each pixel PX.

The common electrode 270, in an embodiment, is on the pixel defining layer 250 and the organic emission layer 260. The common electrode 270, in an embodiment, may be made of a transparent conductive material such as ITO, IZO, ZnO, or In2O3, or a metal such as lithium, calcium, lithium fluoride/calcium, lithium fluoride/aluminum, aluminum, silver, magnesium, or gold. The common electrode 270, in an embodiment, is the cathode of the light emitting device LD.

The encapsulation layer 300, in an embodiment, is positioned on the common electrode 270. The encapsulation layer 300, in this embodiment, encapsulates the light-emitting device LD, thereby preventing (or protecting) penetration of the moisture and/or oxygen from the outside. The encapsulation layer 300, in this embodiment, may include a plurality of encapsulating thin films. For example, the encapsulation layer 300, in an embodiment, may include at least one inorganic layer and at least one organic layer, and the inorganic layer and the organic layer may be alternately deposited.

The inorganic layer, in an embodiment, may be a single layer or multilayer including a metal oxide or a metal nitride. For example, the inorganic layer, in an embodiment, may be (e.g., formed of) one of a silicon nitride (SiNx), an aluminum oxide (AlOx), a silicon oxide (SiOx), and/or a titanium oxide (TiOx). A highest layer that is exposed to the outside in the encapsulation layer 300, in an embodiment, may be formed of the inorganic layer in order to prevent moisture from permeating into the light-emitting device LD.

The organic layer, in an embodiment, may be formed of the polymer, and for example, may be the single layer or the multilayer formed of polyethylene terephthalate (PET), polyimide (PI), polycarbonate (PC), epoxy, polyethylene (PE), and/or polyacrylate.

While this invention has been described in connection with what is presently considered to be practical embodiments, it is to be understood that the invention is not limited to the disclosed embodiments, but, is intended to cover various modifications and equivalent arrangements included within the spirit and scope of the embodiments of the present invention and the appended claims, and equivalents thereof.

Description of Certain Symbols

| | |
|---|---|
| 10: display panel | 100: flexible substrate |
| 61a: switching source contact hole | 61b: driving source contact hole |
| 62a: switching drain contact hole | 62b: driving drain contact hole |
| 63: first contact hole | 110: buffer layer |
| 124a: switching gate electrode | 124b: driving gate electrode |
| 121: gate signal | 128: first capacitor plate |
| 140: gate insulating layer | 160: interlayer insulating layer |
| 154a: switching semiconductor | 154b: driving semiconductor layer |
| layer | |
| 1545a: channel region | 1545b: channel region |
| 1546a: source region of the switching | 1546b: source region of the driving |
| 1547a: drain region of the switching | 1547b: drain region of the |
| | switching |
| 171: data line | 172: driving voltage line |
| 173a: switching source electrode | 173b: driving source electrode |
| 175a: switching drain electrode | 175b: driving drain electrode |
| 178: second capacitor plate | 180: passivation layer |
| 185: second contact hole | 191: pixel electrode |
| 200: display layer | 250: pixel defining layer |
| 260: organic emission layer | 270: common electrode |
| 300: encapsulation layer | |
| 400: touch electrode layer | 410: first touch electrode layer |
| 411: first touch electrode | 415: first touch signal line |
| 412: first connection | 422: second connection |
| 420: second touch electrode layer | 421: second touch electrode |
| 425: second touch signal line | 500: polarization layer |
| 510: ¼λ retarder film | 520: adhesive layer |
| 530, 550: protection film | 540: linear polarizer |
| 600: protection layer | 620: adhesive layer |
| DA: display area | MDA: main display area |
| BDA: bending display area | PA: peripheral area |
| TA: touch active area | PX: pixel |
| Cst: storage capacitor | VDD: driving voltage |
| Qs: switching thin film transistor | Qd: driving thin film transistor |
| Id: output current | LD: light emitting device |
| VSS: common voltage | |

What is claimed is:

1. A display device comprising:
a display panel comprising:
a flexible substrate;
a display layer on the flexible substrate and including an electro-optical active layer;
an encapsulation layer on the display layer; and
a touch electrode layer,
wherein the touch electrode layer comprises:
a first touch electrode layer under the display layer and comprising a plurality of first touch electrodes and a plurality of first touch signal lines coupled to the first touch electrodes; and
a second touch electrode layer on the display layer such that the display layer is between the first touch electrode layer and the second touch electrode layer and comprising a plurality of second touch electrodes and a plurality of second touch signal lines coupled to the second touch electrodes.

2. The display device of claim 1, further comprising a protection layer under the flexible substrate, such that the first touch electrode layer is between the flexible substrate and the protection layer.

3. The display device of claim 2, further comprising a polarization layer on the encapsulation layer, such that the second touch electrode layer is on the polarization layer.

4. The display device of claim 2, further comprising a polarization layer on the encapsulation layer, such that the second touch electrode layer is between the encapsulation layer and the polarization layer.

5. The display device of claim 2, further comprising a polarization layer on the encapsulation layer, wherein the second touch signal line is in the polarization layer.

6. The display device of claim 5, wherein the polarization layer comprises a plurality of layers, and the second touch electrode layer is between two layers of the plurality of layers of the polarization layer.

7. The display device of claim 5, further comprising a display area configured to display an image and a peripheral area around a perimeter of the display area, wherein the display area comprises a main display area and a bending display area at least at one side of the main display area.

8. The display device of claim 7, wherein the bending display area does not include the protection layer.

9. The display device of claim 7, wherein the bending display area is at a right side and/or a left side of the main display area.

10. The display device of claim 9, wherein the first and second touch signal lines are at the peripheral area of the main display area, and do not extend into the bending display area.

11. The display device of claim 10, wherein the display panel further comprises a touch active area configured to sense a touch, the touch active area substantially overlapping with the main display area.

12. The display device of claim 7, wherein the first and second electrode touch layers are at the main display area and the bending display area.

13. The display device of claim 12, wherein the first and second touch electrode layers comprise silver nanowire (AgNW), a metal mesh, carbon nanotubes (CNT), and/or graphene.

14. The display device of claim 1, wherein the first touch electrode and the second touch electrode constitute a mutual sensing capacitor.

15. The display device of claim 14, wherein one of the first touch electrode and the second touch electrode comprises a sensing input electrode, and the other comprises a sensing output electrode.

16. The display device of claim 1, wherein
the plurality of first touch electrodes are positioned in columns, and the first touch electrodes in each column are electrically coupled to each other by a first connection, and
the plurality of second touch electrodes are positioned in columns, and the second touch electrodes in each column are electrically coupled to each other by a second connection.

17. The display device of claim 16, wherein
the columns in which the first touch electrodes are electrically coupled to each other and the columns in which the second touch electrodes are electrically coupled to each other are substantially parallel to each other.

18. The display device of claim 17, wherein
the first touch electrode layer and the second touch electrode layer overlap each other with the display layer interposed therebetween.
